(19) United States
(12) Patent Application Publication
(10) Pub. No.: US 2019/0165508 A1
(43) Pub. Date: May 30, 2019

(54) COUPLING DEVICE

(71) Applicant: EISELE PNEUMATICS GMBH & CO. KG, Waiblingen (DE)

(72) Inventor: Andreas NOTHDURFT, Remshalden (DE)

(73) Assignee: EISELE PNEUMATICS GMBH & CO. KG, Waiblingen (DE)

(21) Appl. No.: 16/313,555

(22) PCT Filed: Jun. 27, 2017
(86) PCT No.: PCT/EP2017/000761

§ 371 Date: Dec. 27, 2018

(30) Foreign Application Priority Data
Jun. 28, 2016 (DE) 10 2016 007 880.4

(51) Int. Cl. H01R 13/00; H01R 13/508; H01R 13/518

(52) U.S. Cl. CPC H01R 13/005; F16L 25/01; H01R 13/518; H01R 13/508

(57) ABSTRACT

The invention relates to a coupling device, comprising two coupling parts (1), which can be detachably connected to each other and which have holders (9) for receiving media-conducting and/or electrically conducting connector parts (11). Said coupling device is characterized in that at least some of the connector parts (11) are provided with a positioning aid (69), which interacts with at least one further positioning aid (63) in the associable coupling part (1) in such a way that the connector part (11) in question is received in said coupling part (1) in a non-interchangeable and accurately fitting manner.

The invention relates to a coupling device having two detachably connectable coupling parts, which have receptacles for receiving media and/or current-carrying connector parts.

Coupling devices of this type, also called multiple couplings, are state of the art. For example, DE 10 2012 001 529 A1 shows a coupling device of this type in the form of a multi-media coupling, in which connector parts, which are connected to line sections conveying compressed air, and current-carrying connector parts come into contact with each other when the coupling parts are plugged together and attached to each other. Frequently, the current-carrying connector parts are designed for a larger number of line sections, such as sensor lines, data lines, power supply lines or communication links, for which associated contact elements, such as pins and jacks are provided. For the reliability of the coupling device and thus the connected electrical systems, it is crucial that during the coupling process the pin/socket contact elements establish the secure contact connection in an exactly aligned manner and that in particular the connector parts are oriented such that associated line sections are connected to each other. Therefore, the connector parts have to be mounted very carefully in the coupling parts, i.e. considerable manufacturing effort is required for the production of the coupling devices.

In view of this problem, the invention addresses the problem of providing a coupling device of the type mentioned, which is simple and efficient to produce and in particular ensures a high level of functional reliability in current-carrying connector parts.

According to the invention this problem is solved by a coupling device having the features of claim 1 in its entirety.

According to the characterizing part of claim 1, this problem is solved according to the invention in that at least a portion of the connector parts is provided with a positioning guide, which cooperates with at least one other positioning guide in each assignable coupling part such that the correct connector part is non-interchangeably and accurately inserted in this coupling part. As a result, there is a non-interchangeability device, by means of which the connection of the contact elements belonging to the same line sections is established with reduced installation effort and a high degree of reliability. The coupling device according to the invention is therefore functionally reliable in a rational and cost-effective manner.

With particular advantage, the positioning guide can be formed on the relevant connector part of at least one guide web projecting on the outer circumference thereof, which engages with a groove-like guide receptacle as the further positioning guide in the assignable coupling part, as soon as the connector part is inserted into the assignable coupling part. As a result, a torque-free arrangement is formed, by which the connector parts are held secured against rotation in the relevant receptacle of the coupling parts in the orientation in which the contact elements to be connected are precisely aligned.

The connector parts connectable to each other in pairs in a detachable manner may be formed as a male and female type of connector parts, wherein the one type is assigned to the one coupling part and the other type to the other coupling part.

In particularly advantageous exemplary embodiments, the arrangement can be made in this respect such that one type of connector parts has a kind of positioning guide, which is different from the type of positioning guide of the other type of connector parts, wherein each type of positioning guides of the connector parts is assigned to a distinct kind of differing positioning guides of the coupling parts. This design of positioning guides not only ensures the exact orientation of the contact elements to be connected (pins/sockets), but also eliminates the possibility of an assembly error where a connector part of the male types is installed in a coupling part provided for female connector parts or vice versa.

Advantageously, several, preferably three, guide webs, preferably arranged at uniformly spaced radial distances, can be arranged along the outer circumference of the connector part, wherein the guide webs engage with corresponding groove-like guide receptacles in the assignable coupling part in its attachment position.

The arrangement may advantageously be made such that, viewed in cross-section, the guide webs of the connector parts are convex, in particular arc-shaped and engage with guide receptacles in the assignable coupling part that, viewed in cross-section, are concave, in particular arc-shaped, the free cross-section of which is dimensioned such that the guide webs are at least partially in contact with the guide receptacles of the assignable coupling part.

The connector parts may preferably be formed in the manner of electric terminals provided with a plurality of electrical contact junctions formed by pins and sockets.

In particularly advantageous embodiments, the relevant connector part has at least one metallic contacting part on its outer circumference, preferably in the form of an expander ring, which is provided for an improved grounding function with the housing of the assignable coupling part. As a result, the grounding, especially important in particular for data, sensor or communication lines, is ensured, possibly in conjunction with cable shields.

Particularly advantageously, the arrangement may be made such that the connector part of the male type has a further metallic contacting part, preferably in the form of a further expander ring, which can be brought into contact with the assignable connector part of the female type for improved grounding functionality. In this way, a direct ground connection is formed between the connector parts of the one coupling part and that of the other coupling part in addition to the ground connection between the connector parts and the coupling housing.

According to claim 10, the subject matter of the invention is also a connector part, in particular in the form of an electric terminal, which is intended for usage in a coupling device according to one of the claims 1 to 9.

Below the invention is explained in detail with reference to exemplary embodiments shown in the drawing.

In the figures:

FIG. 1 shows a longitudinal section of a coupling part designated for receiving the connector parts of the male type of an exemplary embodiment of the coupling device according to the invention, wherein only one connector part received in the housing of the coupling part is shown;

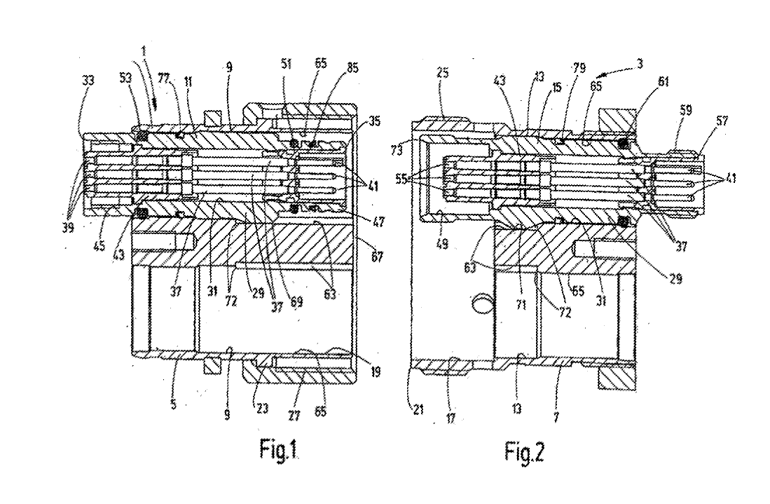

FIG. 2 shows a longitudinal section corresponding to FIG. 1 of the second coupling part of the exemplary embodiment provided for receiving connector parts of the female type, wherein only one connector part received in the housing of the coupling part is shown.

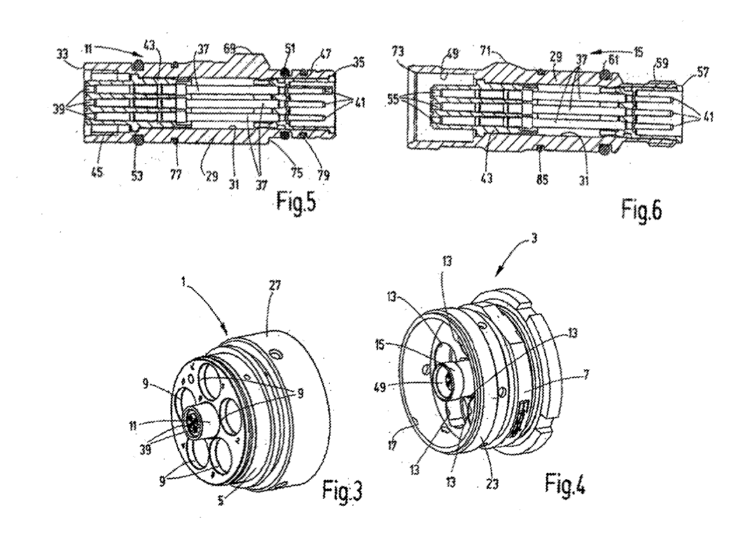

FIG. 3 shows a perspective oblique view of a coupling part designated for receiving the connector parts of the male type in accordance with a second exemplary embodiment of the coupling device, wherein only one connector part received in the housing of the coupling part is shown;

FIG. 4 shows a perspective oblique view of a second coupling part designated for the connector parts of the female type of the second exemplary embodiment, wherein only one connector part inserted in the housing of the coupling part is shown;

FIG. 5 shows a longitudinal section of a male connector part shown separately;

FIG. 6 shows a longitudinal section of a female connector part shown separately;

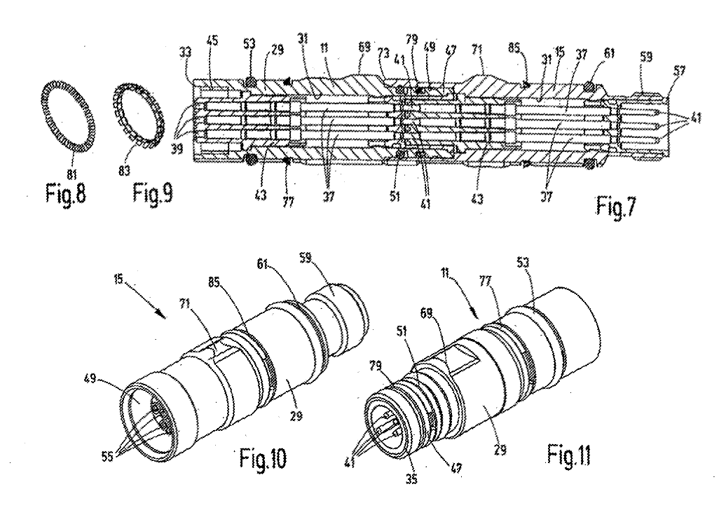

FIG. 7 shows a longitudinal section showing the connector parts of FIGS. 5 and 6 in the mated position for making the connection without the associated coupling parts.

FIGS. 8 and 9 show perspective oblique views of two exemplary embodiments of contacting parts;

FIG. 10 shows an oblique perspective view of the female connector part of FIG. 6;

FIG. 11 shows an oblique perspective view of the male connector part of FIG. 5;

FIG. 12 shows a front view of the female type connector of FIG. 10;

FIG. 13 shows a front view of the coupling part of the second embodiment shown in FIG. 4 having an inserted connector part of the female type.

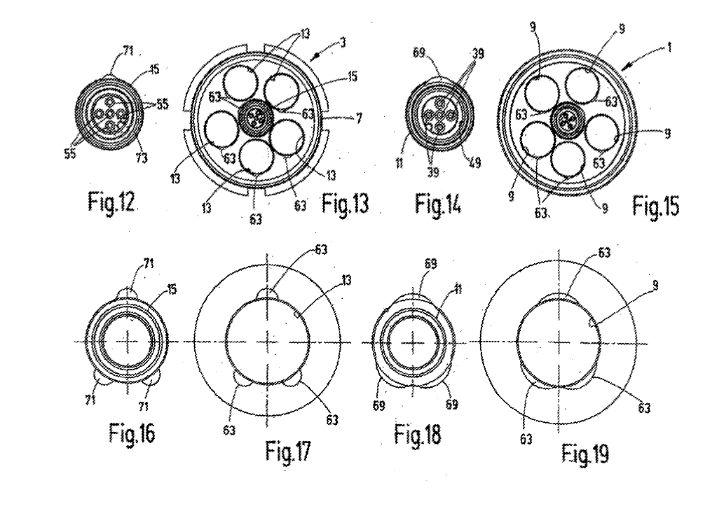

FIG. 14 shows a front view of the male type connector of FIG. 11;

FIG. 15 shows a front view of the coupling part of the second exemplary embodiment shown in FIG. 3 having an inserted connector part of the male type.

FIG. 16 shows an end view of a connector part of the female type having several projecting guide webs forming positioning guides;

FIG. 17 shows a front view of a receptacle in the coupling part, not shown, for the connector part of FIG. 16;

FIG. 18 shows an end view of the connector part of the male type having several projecting guide webs forming positioning guides; and

FIG. 19 shows a front view corresponding to FIG. 17 of the receptacle provided for the connector part of FIG. 18 without the associated coupling part.

FIGS. 1 and 2 show a first coupling part 1 and second coupling part 3 for a first exemplary embodiment of the coupling device according to the invention. The coupling parts 1 and 3 each have a metallic housing 5 and 7, which is largely circular-cylindrical. In the housing 5 of the first coupling part 1 four continuous, channel-like connector receptacles 9 are formed, which are each provided for receiving a connector part 11 of the male type. FIG. 1 shows a connector part 11 in only one receptacle 9. The second coupling part 3 has connector receptacles 13 matching the receptacles 9 of the first coupling part 1, which receptacles are provided for receiving connector parts 15 of the female type, wherein, as shown in FIG. 1, only one connector part 15 received in a receptacle 13 is shown. To establish the connection between the male parts 11 and 15, the coupling parts 1 and 3 are plugged into a coupling position in which a shell part 17 of the second coupling part 3 extends over a shell part 19 of the first coupling part 1, wherein in the coupling position, the end 21 of the shell part 17 rests against a radially protruding annular body 23 of the first coupling part 1. To attach the coupling parts 1 and 3 in this coupling position, the second coupling part 3 on the shell part 17 has a male thread 25 to which a union nut 27 of the first coupling part 1 is screwed, which is guided on the annular body 23.

FIGS. 3 and 4 show the first coupling part 1 and the second coupling part 3 of a second exemplary embodiment of the coupling device according to the invention, wherein the housings 5 or 7, as in the example of FIGS. 1 and 2, can be attached to each other by means of screwing a union nut 27 to a male thread 25. The difference to the first embodiment is merely that six receptacles 9 with a coaxially arranged, central receptacle 9 are provided in the housings 5 and 7. Of these, only the coaxial receptacle 9 equipped with a male part 11 of the male type is shown in FIG. 3, whereas FIG. 4 only shows a connector part 15 of the female type inserted in the coaxial receptacle 9.

The details of the connector parts 11 and 15 are the most clearly shown in FIGS. 5 to 7, in which the connector parts 11 and 15 are shown separately, which are each so-called electric terminals. FIGS. 5 and 11 show a detail view of the male connector part 11 in and FIGS. 6 and 10 and a detail view of the connector part of the female type 15. The male connector part 11 has a continuous channel 31 in the form of a round body 29 in its metallic connector housing. A bundle of electrical conductors 37 isolated from each other runs from the connection end 33 of the channel 31 on the left in FIGS. 1, 5 and 7, which connection end protrudes from the coupling part 1 in its functional position inserted into the latter, cf. FIG. 1, to the opposite end of the connection 35 in the channel 31. These are terminated at the connection end 33 using terminals 39 for the connection of line sections not shown. The conductors 37 terminate in connector pins in the form of so-called pins 41 right before the opposite connection end 35. As is customary with electric terminals, the insulating body 43 of the bundle of conductors 37 is used to secure the latter against axial displacement in the channel 31, and a female thread for a line connection fitting (not shown) is formed at the connection end 33 surrounding the connection terminals 39. In the end section adjacent to the opposite connecting end 35, the body 29 forms an insertion part 47 having a reduced outer diameter, which engages in the coupling position as shown in FIG. 7 with a channel extension 49 of the female connection part 15 in a fitting manner, wherein an O-ring 51 is provided on the insertion part 47 of the connector part 11 for sealing purposes. A second O-ring 53 forms the seal towards the housing 5 of the coupling part 1 in the vicinity of the connecting end 33.

The female connector part 15, which like the connector part 11 is formed as an electric terminal having a round body 29, also has a continuous channel 31 for the bundle of electrical conductors 37 located in the isolating body 43, which conductors terminate at the end facing the male connector part 11 in sockets 55, which are located in the extension 49 of the round body 29 and, in the functional position, are aligned with the pins 41 of the connector part 11. The body 29 is reduced in diameter and provided with a male thread 59 at the connection end 57 opposite from the extension 49. It can be used to screw a connection socket to the line sections not shown, via which the electrical connection to the pins 41 of the conductor 37 of the female connector part 15 can be established. An O-ring 61 for sealing to the housing 7 of the associated coupling part 3 is located at the transition of the end area having the male thread 59 to the non-tapered outer periphery of the body 29.

In the non-tapered sections of their bodies 29, both connector parts 11 and 15 have the same diameter as that of the place of reception in their associated receptacle 9 and 13 of the housing 5 and 7 of the relevant coupling parts 1 and 3, respectively. The receptacles 9 in the first coupling part 1 have, as part of a positioning guide for the connector parts 11, a guide receptacle in the form of a groove 63, which extends as a recess along the inner wall 65 of the relevant receptacle 9 from the end 67 facing the other coupling part 3 in the axial direction. The groove 63 forms the guide receptacle for a further part of the guide web 69 forming the positioning guide, which protrudes radially on the outside of the body 29. The shape and axial length of the guide web 69 can best be seen in FIG. 11. As shown, the guide web 69 forms a convex elevation having circular arc-shaped cross-section. The groove 63 in the coupling part 1 is adapted to this convexity, such that the guide web 69 engages with the groove 63 in a fitting manner. The length of the groove 63 and the axial length of the guide web 69 are selected such that the inner end 72 of the groove 63 in conjunction with the guide web 69 determines the axial position of the connector part 11 in the coupling part 1, wherein the connector part 11 is secured against axial displacement to the left in FIG. 1.

In a corresponding manner, a groove 63 is formed as a recess in the inner wall 65 of the relevant receptacles 13 in the second coupling part 3 in the receptacles 13, which, together with a projecting guide web 71 of the body 29, forms the positioning guide for the connector part 15. As is most clearly shown in FIG. 10, the guide web 71 is, just like the guide web 69, convexly curved with an arc-shaped cross-section, but has a shorter axial length than the guide web 69. The axial position of the connector part 15 is defined in the coupling part 3 in conjunction with the inner end 72 of the groove 63 and the selected axial length of the guide web 71, wherein the connector part 15 is secured against axial displacement to the right in FIG. 2. With the different axial lengths of the guide webs 69 and 71 and the relevant groove 63, the coupling process can only be successfully performed if the connector parts 11 and 15 of the associated type are installed in the coupling parts 1 and 3.

To ensure a secure ground connection of the male connector part 11 to the housing 5 of the coupling part 1, a metallic contacting part 77 in the form of an expander ring is arranged on the outer circumference of the body 29 in the area between the O-ring 53 and the guide web 69. A further such contacting part 79 is arranged on the outer circumference of the insertion part 47. FIGS. 8 and 9 show examples of contacting parts in the form of a spring ring formed from spring coils 81 or a lamellar sheet metal ring 83. The contacting part 79 forms a direct ground connection to the connector part 15 on the inside of its extension 49. The connector part 15 also has such a contacting part 83 in the area between the guide web 71 and the O-ring 61, which improves the grounding between the connector part 15 and the housing 7 of the coupling part 3.

FIG. 13 shows the front view of the housing 7 of the second exemplary embodiment of the coupling part 3 shown in FIG. 4 having only one female connector part 15 inserted in the centrally located receptacle 13. A front view of this female connector part is shown enlarged in FIG. 12. FIG. 13 shows the grooves 63 assigned to every receptacle 13, which have an arched cross-section as guide receptacles, the shape of which is adapted to the arched shape of the guide web 71, cf. FIG. 12. In a similar manner, FIG. 15 shows the grooves 63 in the receptacles 9 of the first coupling part 1 having a flatter and wider shape, which is adapted to the cross-sectional shape of the guide web 69, cf. FIG. 14, of the connector part 11. FIGS. 16 and 17 show the corresponding conditions for an exemplary embodiment modified further, in which three guide webs 71 are provided on the outer circumference of the connector part 15 in a distributed arrangement, the cross sections of which correspond to the arc-like shape of the guide web 71 of FIG. 12. For these guide webs 71, as shown in FIG. 17, the grooves 63 in the relevant receptacle 13 are formed in a corresponding shape. FIGS. 18 and 19 show the conditions for guide webs 69 of the flatter, wider convex cross-sectional shape for three circumferentially distributed guide webs 69, for which in turn, as shown in FIG. 19, the grooves 63 in the relevant receptacle 9 are formed in an adapted shallow concave shape.

1. A coupling device having two detachably connectable coupling parts (1, 3) having receptacles (9, 13) for receiving media and/or current-carrying connector parts (11, 15), characterized in that at least a portion of the connector parts (11, 15) is provided with a positioning guide (69, 71), which interacts with at least one further positioning guide (63) at the assignable coupling part (1, 3) in such a manner that the relevant connector part (11, 15) is received non-interchangeably and precisely fitting in this coupling part (1, 3).

2. The coupling device according to claim 1, characterized in that the positioning guide is formed on the relevant connector part (11, 15) of at least one guide web (69, 71) projecting on the outer circumference thereof, which engages with a groove-like guide receptacle (63) as the further positioning guide in the assignable coupling part (1, 3), as soon as the connector part (11, 15) is inserted into the assignable coupling part (1, 3).

3. The coupling device according to claim 1 or 2, characterized in that the axial length of the groove-like guide receptacle (63) and the axial length of the guide web (69, 71) are selected such that the inner end (72) of the guide receptacle (63) in conjunction with the guide web (69, 71) define the axial position of the connector part (11, 15) in the coupling part (1, 3) and that the connector part (11, 15) is secured against axial displacement in the direction of the inner end (72) of the guide receptacle (63).

4. The coupling device according to claim 1, characterized in that male (11) and female (15) types of connector parts (11, 15) are present, which can be connected to each other in pairs in a detachable manner, and that the one (11) type is assigned to the one coupling part (1) and the other (15) type is assigned to the other coupling part (3).

5. The coupling device according to claim 1, characterized in that in order to establish a connection between the connector parts (11, 15), the coupling parts (1, 3) can be connected in a coupling position, wherein a shell part (17) of the second coupling part (3) extends over a further shell part (19) of the first coupling part (1) and that in the coupling position one end (21) of one shell part (17) is in contact with a radially protruding annular body (23) of the first coupling part (1).

6. The coupling device according to claim 1, characterized in that for attaching the coupling parts (1, 3) in their coupling position, the second coupling part (3) has a male thread (25) on its shell part (17) to which a union nut (27) of the first coupling part, which is guided on the annular body (23), (1) can be screwed.

7. The coupling device according to claim 1, characterized in that in a coupling position of male (11) and female (15) connector parts, the end section of the body (29) of the male connector part (11) adjacent to its connecting end (35) has an insertion part (47) with a reduced outer diameter, which engages with a channel extension (49) of the female connector part (15) in a fitting manner.

8. The coupling device according to claim 1, characterized in that an O-ring (51) is provided on the insertion part (47) of the male connector part (11) for sealing the engagement of the male connector part (11) in the female connector part (15).

9. The coupling device according to claim 1, characterized in that the one (11) type of connector parts (11, 15) has a type (69) of positioning guides (69, 71), which differs from the type (71) of positioning guides (69, 71) of the other type (15) of connector parts (11, 15), and that a distinct kind of different positioning guides (63) of the coupling parts (1, 3) is assigned to each type (69, 71) of positioning guides of the connector parts (11, 15).

10. The coupling device according to claim 1, characterized in that several, preferably three, guide webs (69, 71), are preferably arranged at uniformly spaced radial distances along the outer circumference of the connector part (11,15), which guide webs engage with corresponding groove-like guide receptacles (63) in the assignable coupling part (1, 3) in their attachment positions.

11. The coupling device according to claim 1, characterized in that the guide webs (69, 71) of the connector parts (11, 15) are convex, in particular arc-shaped and engage with guide receptacles (63) in the assignable coupling part (1, 3) that, viewed in cross-section, are concave, in particular arc-shaped, the free cross-section of which is dimensioned such that the guide webs (69, 71) are at least partially in contact with the guide receptacles (63) of the assignable coupling part (1, 3).

12. The coupling device according to claim 1, characterized in that the connector parts (11, 15) are formed in the manner of electric terminals, having several electrical contact connection points (41, 55).

13. The coupling device according to claim 1, characterized in that the relevant connector part (11, 15) has at least one preferably metallic contacting part (77, 85) on its outer circumference, preferably in the form of an expander ring, for improved grounding function with the housing (5, 7) of the assignable coupling part (1, 3).

14. The coupling device according to claim 1, characterized in that the male connector part (11) has at least one further metallic contacting part (79), preferably in the form of another expander ring, which can be brought in contact with the assignable female connector part (15) for an improved grounding functionality.

15. The coupling device according to claim 1, characterized in that in interconnected connector parts (11, 15) the individual contacting parts (77, 85) are electrically isolated from each other and from the environment by means of an isolating device, which is preferably formed from a sealing system and individual sealing rings (51, 53, 61).

16. A connector part, in particular in the form of an electric terminal (11, 15), intended for use in a coupling device according to claim 1, characterized in that it has at least one positioning guide (69, 71) and an electrical contacting part (77, 79, 85).
